(19) United States
(12) Patent Application Publication
(10) Pub. No.: US 2007/0288502 A1
(43) Pub. Date: Dec. 13, 2007

(54) SYSTEMS AND METHODS FOR COMPARING, RETREIVING, AND REPORTING DATA

(75) Inventor: Ian Silverthorne, Ladera Ranch, CA (US)

Correspondence Address: KNOBBE MARTENS OLSON & BEAR LLP, 2040 MAIN STREET, FOURTEENTH FLOOR, IRVINE, CA, 92614, US

(73) Assignee: Treatment First, Inc., Ladera Ranch, CA (US)

(21) Appl. No.: 11/742,497

(22) Filed: Apr. 30, 2007

Related U.S. Application Data
(60) Provisional application No. 60/796,364, filed on Apr. 28, 2006.
(60) Provisional application No. 60/818,265, filed on Jun. 30, 2006.

(51) Int. Cl. G06F 17/30

(52) U.S. Cl. 707/102; 707/E17.005

(57) ABSTRACT

A system is described that allows users to conveniently search for and exchange information. In some embodiments, a web service allows for personal injury attorneys to locate medical providers according to their geographic location, specialty, and fee arrangement. Users may advantageously identify preferred members or providers, and those providers are emphasized on any map or listing in which they appear. Accordingly, attorney users may more efficiently provide clients with medical provider referrals utilizing the systems described herein.

### CROSS-REFERENCE TO RELATED APPLICATIONS

This application claims the benefit of U.S. Provisional Application No. 60/798,364, filed Apr. 28, 2006 and U.S. Provisional Application No. 60/818,265, filed Jun. 30, 2006. The entirety of each of these applications is hereby incorporated by reference, and each is hereby made part of this specification.

### BACKGROUND

1. Field

Some embodiments disclosed herein relate to computer systems for comparing, retrieving, and reporting data between various user groups. Reports can be automatically generated using a computer hardware and software system. For example, searchable data can be used by different providers (e.g., legal and medical providers), and advantageous systems are disclosed for generating, organizing, retrieving, and/or delivering that data.

2. Description of the Related Art

In the past, reporting and data systems have been inefficient and cumbersome. For example, reports have been generated manually by workers, rather than automatically using a computer system, as disclosed herein. Data has been exclusive to a single provider, without web connectivity and network capabilities, as disclosed herein. Moreover, old systems did not integrate geographical search capabilities, as disclosed herein. Many additional features discussed herein have also not been known or available in the past.

### SUMMARY

Embodiments described herein have several features, no single one of which is solely responsible for their desirable attributes. Without limiting the scope of the inventions as expressed by the claims, some of the advantageous features will now be discussed briefly.

According to some embodiments, a system is described for communicating a provider list to a user. The system comprises a database of providers, a list of providers geographically selected from the database, and a group of chosen providers. The system further comprises a display showing the list of providers geographically selected from the database and emphasizing any providers that are in the list and in the group of chosen providers. In some embodiments, the database of providers comprises a database of medical service providers that accept liens. In some embodiments, the database of providers comprises a database of legal service providers for personal injury cases. In some embodiments, the list of providers geographically selected from the database comprises providers within a radius of geographic distance from a user-selectable location. In some embodiments, the list of providers geographically selected from the database comprises providers within a drive-time radius of a user-selectable location. In some embodiments, the group of chosen providers is selectable by a user. In some embodiments, the display showing the list of providers geographically selected from the database and emphasizing any that are in the list of geographically-selected providers and in the group of chosen providers comprises a list that positions chosen providers at the top of the list.

According to some embodiments, a computer implemented method of integrating chosen selections into a geographically-selected list is described. A database of potential providers is provided and a user is allowed to provide place data. Using a computer and the place data, a geographically-selected list may be generated from the database of potential providers. The user may be allowed to choose selections from the database of potential providers. A calculation is made to determine which providers from the database are both on the geographically-selected list and the list of chosen selections, and it is indicated to a user which providers from the database are both on the geographically-selected list and the list of chosen selections. In some embodiments, the method further comprises generating a graphic representation of the geographically-selected list for display to the user. In some embodiments, generating a graphic representation of the geographically-selected list comprises rendering a map. In some embodiments, providing a database of potential providers comprises providing a database of potential service providers that accept deferred payment based on the outcome of a legal proceeding. In some embodiments, providing a database of potential service providers that accept deferred payment based on the outcome of a legal proceeding comprises providing a database of personal injury lawyers. In some embodiments, providing a database of potential service providers that accept deferred payment based on the outcome of a legal proceeding comprises providing a database of medical professionals that accept liens. In some embodiments, allowing a user to provide place data comprises allowing a user to enter an address. In some embodiments, indicating to a user which providers from the database are both on the geographically-selected list and the list of chosen selections comprises displaying a list of providers on a computer screen. In some embodiments, allowing a user to choose selections from the database of potential providers comprises displaying a list of potential providers to a user over a web interface and accepting input from the user regarding each of the providers separately. In some embodiments, indicating to a user which providers from the database are both on the geographically-selected list and the list of chosen selections comprises displaying a list of selected providers to a user over a web interface.

According to some embodiments, a system is provided for communicating provider information to a user. The system comprises a database of providers. A geographic search engine is configured to accept location data and select close providers from the database of providers. A web-based interface is provided that is configured to accept input from the user and display provider information to the user and a tracking system is configured to store information relating to the input from the user. A report generator is configured to retrieve the information relating to the input from the user and display that information to the user. In some such embodiments, the database of providers comprises information relating to medical providers. In some embodiments, the database of providers comprises information relating to providers of legal services. In some embodiments, the database of providers comprises information relating to providers of legal and medical services. In some embodiments, the database of providers comprises information relating to providers of car repair services. In some embodiments, the geographic search engine configured to select close providers from the database of providers is further configured to select close providers according to a user-selected parameter. In some embodiments, the report generator is further configured to retrieve information stored by the tracking system. In some embodiments, the report generator is further configured to display a report showing what medical providers at least one client was referred to. In some embodiments, the report generator is further configured to display a report showing what medical providers received a client from the user. In some embodiments, the report generator is further configured to display a report showing how many times, during a given time period, the geographic search engine accepted location data and selected close providers within a certain geographic area. In some such embodiments, the certain geographic area is a municipality. In some embodiments, the report generator is further configured to display a report showing the number of clients referred to one or more providers for a given time period. In some embodiments, the report generator is further configured to display a report showing all the clients that were referred to providers by a user. In some embodiments, the report generator is further configured to display a report showing the clients referred to each provider for a given time period. In some embodiments, the system further comprises a list of user-selected favorites, selected from the database of providers. In some such embodiments, the report generator is further configured to display a report showing the list of user-selected favorites. In some embodiments, the report generator is further configured to display a report showing all providers that referred clients to a user during a given time period. In some embodiments, the report generator is further configured to display a report showing which providers are using the system to enter location data into the geographic search to locate other providers within a certain geographic area, and that geographic area is selected by the user. In some such embodiments, the user is one of the other providers. In some such embodiments, the report also indicates to the user how many times the geographic search has been used by at least one of the providers. In some embodiments, the report generator is further configured to display to a provider a report that was generated by a different user. In some embodiments, the system further comprises a “favorites only” mode, wherein the web-based interface is configured to display only providers that are also user-identified favorites. In some embodiments, the system further comprises a letter generator configured to generate letters addressed to one or more providers from a user. In some such embodiments, the letter generator is configured to send data from the tracking system to a system administrator.

According to some embodiments, a method is provided for generating reports. The method comprises providing a database of legal and medical providers. Client location data is input by a user. A computer is used to search the database in order to identify legal or medical providers close to the client location, and the search and provider information is stored. A report is automatically generated including the stored search or provider information, and the report is provided to a user.

According to some embodiments, a system is described that allows different user types to interact and exchange information. In some embodiments, a web site allows personal injury attorneys and medical providers that work with personal injury attorneys to search for and locate the others.

If a user is an attorney, for example, the systems and methods described herein provide many advantages for organizing and streamlining a crucial step in the user's client intake process. For example, a user can be allowed to instantly find a doctor in a location that is convenient to the user's client. The system (e.g., a website) can feature hundreds of medical providers, all organized in to specialties and mapped for the user or the user's employee's convenience. An attorney may simply input a client address, and a map can be rendered and nearby provider locations can be generated.

Advantageously, if a user has a list of favorite or otherwise chosen medical providers that the user already works with, the user can simply designate (e.g., select them with a check box) as “favorites” in the user's account and the user can know instantly when one of them is within range of one of the user's clients. The chosen selections (e.g., user favorites) may be emphasized by, for example, having a unique marker on the rendered map or being listed near the top of the list of providers.

Beside each provider name in a list near the map can be a button that allows the attorney to input additional information about a referred client. This information may be stored discretely in a database, along with address information, and may be used to generate reports for the attorney, increasing the usefulness of the site.

### BRIEF DESCRIPTION OF THE DRAWINGS

The following drawings and the associated descriptions are provided to illustrate embodiments of the present disclosure and do not limit the scope of the claims.

FIG. 1 illustrates a system for entering, comparing, retrieving, and reporting data.

FIG. 2 illustrates an example embodiment of the system of FIG. 1.

FIGS. 3A-B are example graphical interfaces showing features of a website created according to some embodiments.

FIG. 4 illustrates data entry and organization by one user type.

FIGS. 5A-5E illustrate data as organized into reports for one user type.

FIGS. 6A-6E illustrate data as organized into reports for another user type.

FIG. 7 illustrates data as organized into reports for yet another user type.

FIGS. 8A-H are example graphical interfaces demonstrating features of website created in accordance with disclosed embodiments.

### DETAILED DESCRIPTION OF THE PREFERRED EMBODIMENT

Although certain preferred embodiments and examples are disclosed below, inventive subject matter extends beyond the specifically disclosed embodiments to other alternative embodiments and/or uses, and to modifications and equivalents thereof Thus, the scope of the inventions herein disclosed is not limited by any of the particular embodiments described below. For example, in any method or process disclosed herein, the acts or operations of the method or process may be performed in any suitable sequence and are not necessarily limited to any particular disclosed sequence. For purposes of contrasting various embodiments with the prior art, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein. The systems and methods discussed herein can be used anywhere, including, for example, in law firms, hospitals, healthcare facilities, or residences. Moreover, the systems and methods discussed herein can be used for user types other than attorneys or medical providers, such as with vendors desiring to easily locate preferred suppliers.

Personal injury attorneys often serve clients that, in addition to seeking help in legal matters, also need assistance in obtaining medical care. Finding a medical provider that understands the process of a personal injury case may be difficult for a client. Such clients often must await a settlement or judgment in order to pay for the treatment of their injuries. These situations may require the client to find a medical provider willing to work on a lien. Many medical providers are not willing to do so. Attorneys that can assist in the process of finding a suitable medical provider offer a valuable service to their clients and are better able to retain those clients. A client that is left to find a medical provider on their own may find a new attorney as well.

Traditionally, personal injury attorneys have kept their own personal records and accumulated personal knowledge about which doctors would accept liens for payment, and which doctors were trusted providers. Thus, many attorneys refer to doctors that provide superior service and have superior expertise. Thus, when someone that has been injured seeks the attorney's help, the attorney may refer the client to a preferred doctor, based on prior experience with that doctors medical services. Indeed, an attorney's prior contact with a doctor can provide the knowledge that the doctor is willing to work on a lien and is otherwise familiar with the needs of a patient in the midst of a personal injury lawsuit.

While this personal knowledge may be useful, it can be difficult to accumulate and retain this knowledge. Furthermore, the amount of knowledge can be limited. It takes time and effort for an attorney to become knowledgeable and comfortable with local doctors. That knowledge is usually limited to a small geographical area. If a client is seeking help in another location or if the attorney or a doctor moves, the attorney may be forced to spend additional time finding new medical providers. Additionally, there are many medical specialties, making it more difficult for an attorney to develop a complete knowledge-base of local doctors for making referrals. Many attorneys must hire additional employees to locate medical providers and keep records of their client's status with those providers.

Common resources available to attorneys today do not completely solve these problems. While print listings or advertisements may identify some suitable medical providers, searching these resources tends to require a significant time commitment and does not assist in identifying preferred medical providers.

Such search methods also do not allow for the efficient tracking of referrals, client intake, and other data that may assist an attorney in efficiently running or marketing his or her firm. If an attorney wishes to record or analyze these types of client data, he or she may be required to spend additional money hiring employees largely dedicated to these tasks.

Thus, there is a need for a system that allows service providers (e.g., personal injury attorneys) to easily find other provides (e.g., medical providers) willing to work on a lien while requiring less time and money than traditional solutions. Furthermore, there is a need for a system that allows attorneys to easily identify preferred medical providers and doctors they have confidence in and about whom they have knowledge. There is a need for a system to more easily allow attorneys and medical providers access to data related to their referral networks and client intake.

There is also a need for doctors to more efficiently maintain, accumulate, and review information in the personal injury context. For example, doctors have a need to efficiently refer personal injury cases to attorneys. The same principles described above regarding gathering knowledge about preferred doctors also applies as doctors gather knowledge about preferred attorneys. The systems and methods described herein provide solutions for these needs.

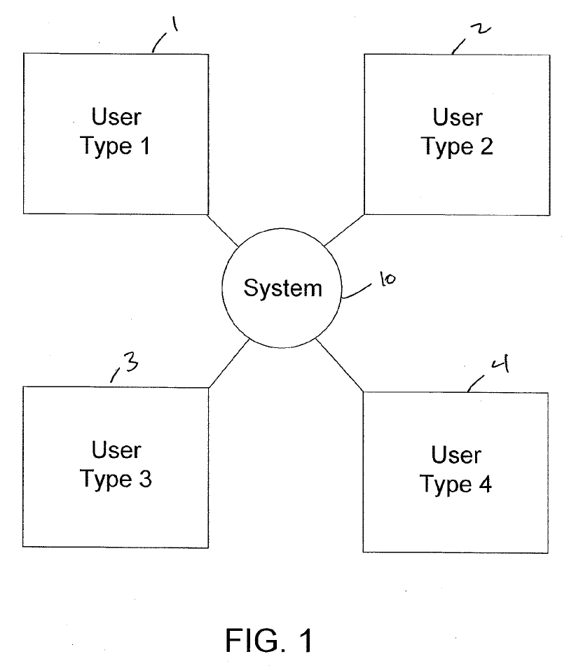

FIG. 1 shows a system 10 for entering, comparing, retrieving, and reporting data. The system 10 can also be used to identify users and to create data connections between different user types 1, 2, 3, and 4. Each user type 1, 2, 3, and 4 may represent one or more users. In one example embodiment, user type 1 can be one or more service providers that seek data from user type 2 in order to provide assistance to a third party (not shown) or to another user type 4. User type 2 can also be one or more service providers that have data sought by user type 1, while at the same time seeking data from user type 1. Thus, user types 1 and 2 can each have different data, and each can seek data from the other. In some embodiments, that data can relate to a third party. User types 1 and 2 can both be providers. For example, user type 1 can be a legal service provider, and user type 2 can be a medical service provider. User type 3 can be one or more service providers that seek to facilitate the transfer of data between user type 1 and user type 2. As with user types 1 and 2, user type 3 can also be a provider (e.g., a marketing services provider). For example, user type 3 can also analyze the data for the benefit of user types 1 and 2. User type 4 can be one or more clients seeking assistance from user types 1 and/or 2. In some embodiments, user type 4 can access the system 10 directly as shown in FIG. 1. In some embodiments, user type 4 receives information from system 10 indirectly through user type 1 or user type 2. The system 10 can assist in finding users of the four types, in finding the data sought by the users of the four types, and in transferring the data between user types. In some embodiments, only user types 1 and 2 are connected to system 10.

User Entities

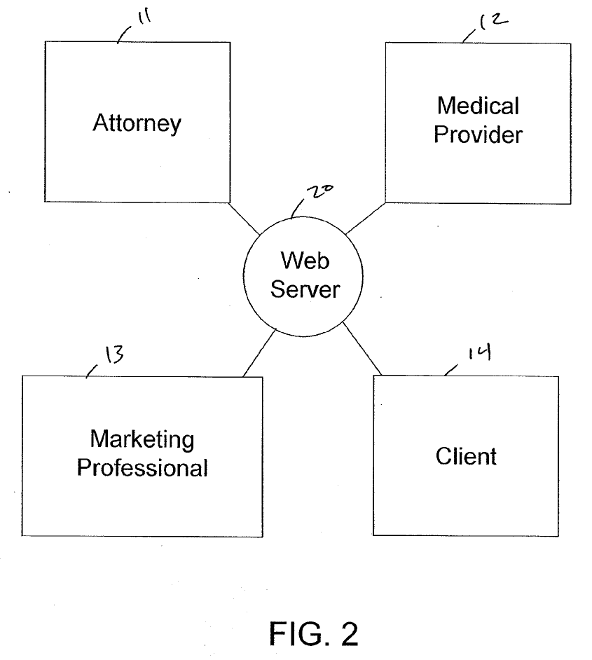

Any and/or all of the following entities can be users of the system described herein, as illustrated in FIG. 2:

User type 1 can be one or multiple attorneys, (e.g., an attorney 11), such as a personal injury attorney, that uses the system (e.g., a website with a web server 20) as a source for conveniently located medical provider offices near the attorney's clients. By inputting place data (e.g., an address), an attorney 11 can be provided with a list of medical providers 12, as well as a map, with locations that can conveniently serve the attorney's clients. The attorney 11 may also be provided with space for the recording of the names and dates-of-injury of the clients he refers to the medical provider. The attorney 11 can also be allowed to select favorite medical providers that will be emphasized (e.g., by being listed first) when they are within a given distance of the place data.

User type 2 can be one or multiple medical providers (e.g., medical provider 12) that list(s) location(s) on the system, which can comprise a web server 20. The medical provider's goal in subscribing to the web service can be, for example, to make available its office locations (e.g., those locations that subscribe to the service) to searching attorneys 11. The medical provider 12 may also subscribe in order to gain access to the office locations of attorneys 11, to manage and/or obtain information related to patient intake, or the like. In a preferred embodiment, medical providers 12 may be a large group of those providers that work on a lien and are familiar with practices for serving personal injury clients.

User type 3 can be one or multiple marketing professionals (e.g., a marketing professional 13) that use(s) the site to receive detailed reports about the business being referred to or from medical providers 12 and attorneys 11. In some embodiments, an attorney 11 or a medical provider 12 indicates that they are doing business with a marketing professional 13, thereby allowing that marketing professional 13 to have access to, and/or assist with creating and maintaining, data from the web server 20. In some embodiments, the marketing professional 13 can also receive one or more reports that detail these statistics for all medical providers 12 and/or attorneys 11 that list the marketing professional 13 as doing work with them.

User type 4 can be a client 14 that uses the site to find attorneys 11 or medical providers 12. In some embodiments, the client 14 gains access to web server 20 using a password or code provided by an attorney 11 or medical provider 12. In some embodiments, this password or code is associated with a list or map provided to the attorney 11 or medical provider 12 and allows the client 14 to remotely retrieve that information. In some embodiments, client 14 has direct access to web server 20 and may obtain lists of attorneys 11 and medical providers 12 without a code.

The system 10 can be a web server 20 that provides a database and mapping system that collects usage statistics, location search statistics, and other data collected from the use of the site by attorneys 11 and medical providers 12. The web server can also provide location maps that are centered on the address input to provide the attorney 11 with the locations of medical providers 12 that are near that address. In some embodiments, the web server 20 communicates with external web services in order to provide the desired functionality.

The relationships between the various users and the system, according to some embodiments, can be described as follows. The relationship between the medical provider 12 and web server 20 is such that the medical provider 12 can supply data in the form of office locations for the attorney 11 to search. The relationship between the marketing professional 13 and web server 20 is such that the marketer 13 receives reports from the web server 20. The relationship between the attorney 11 and web server 20 can be such that the attorney 11 uses the web server 20 to locate medical providers 12 to refer clients to. The attorney 11 can also input client data and generate reports. Each of these entities can also enter data into the system relating to the existence and/or information of any other entities known to the user. The relationship between the client 14 and the web server 20 can be such that the client 14 uses the web server 20 to locate medical providers 12 or attorneys 11. In some embodiments, the relationship between the client 14 and the web server 20 can be such that client 14 uses the web server 20 to review a list of medical providers 12 found by attorney 11.

Thus, in some embodiments, the system discussed herein is an online medical provider locator system that allows attorneys to find medical providers geographically near to a specific location. The website may be used, in some embodiments, by four types of users: attorneys, medical providers, marketing professionals, and clients. In some embodiments, the system receives an address from an attorney user and generates a map and location data, allowing the attorney to refer a client to a local medical provider. Through the natural use of the site and its intended purpose, the system collects data that are used to create various reports. These reports can be used to more effectively target marketing efforts, keep track of client referrals, report on the areas from which new clients are coming, etc. New reports can be conceived from the data that is collected through the natural use of the site. The reports are generated for each of the intended users. Another feature of the site is the function that allows an attorney to designate medical providers as “favorites” within their accounts. Attorneys can sign up for an account to use the site for looking up medical providers for their clients, as well as to keep track of what clients are referred to which medical providers. A medical provider can sign up on the site to have their location listed to be available for attorneys. A marketing professional can sign up to receive the reports automatically (e.g., by email or regular mail) at the end of every month from each of their clients, as well as to receive reports that are generated for the marketing professional's specific clients.

System Designs

One example of the system described above with respect to FIGS. 1 and 2 can include a server that can be accessed by users over the world wide web. The users can communicate with the server and its databases by way of a graphical user interface that is designed to be displayed on the world wide web, and can be programmed in hyper-text machine language or html, for example. This server (including databases) and user interface can be collectively referred to as a “website.” Such a website can be programmed to be as robust and reliable as possible, utilizing industry standards for website design. The site can be hosted on a Windows NT server based machine, for example. In some embodiments, the web site can be hosted by a premium hosting service such as may be available at “1and1.com,” for example. In a preferred embodiment, the site is designed to be moved to another host if desired. In a preferred embodiment, the website has a “blade” configuration setup in a hot swappable rack from Dell.

In some embodiments, a website that can perform some or all of the data functions described herein can have a trade-name, trademark, and/or logo. In a preferred embodiment, the website can be called “treatment1st.com” or “treatmentfirst.com,” for example. As used herein, the terms “treatmentfirst.com,” “treatmentfirst,” “treatment1st.com, “TreatmentFirst,” “TreatmentFirst.com,” etc. are not intended to be limiting, but instead refer to a system that can comprise some or all of the features described herein. If a website, feature, functionality, etc. is described as it applies to “treatmentfirst.com,” for example, that website, feature, or functionality is intended as a non-limiting example. Similarly, a website with such a feature or functionality can have any name and still fall squarely within the scope of this specification. None of the specific terms used to refer to functionality described herein are intended to be limiting. Thus, a “report” need not be called by that name, but could alternatively could be referred to as a “data collection,” or a “snapshot view,” or an “information capture,” or an “overview download,” etc. Moreover, the features and functions described herein can be adapted to many computer environments that do not include the world wide web, so any references to the world wide web or “the website” are not limiting but only intended as examples.

Accounts

Many account structures and charging protocols can be employed. In one non-limiting example, attorneys (e.g., legal providers) and medical providers can have different account types. The attorney can log on to the site to use it, while a medical provider can log on to subscribe or to update his or her account information. In some embodiments, attorneys can use the site to find medical providers at no charge.

The website can allow providers to sign up for a monthly fee. The sign up can be accomplished through an on-line form, with the provider checking what specialty or field they want to belong to. For example, a provider can be a chiropractor, an orthopedic surgeon, etc. The following is a nonexclusive list of information that can be advantageously collected when a medical provider signs up for a new account: Office Name, Lead Doctor Name, Lead Doctor License Number, Provider Specialties, Office Address, Office Phone Number, Office Contact Person, Office email address, Login name, Login password, etc. There may be different fees according to different specialties. In some embodiments, the provider can have the option of designating multiple medical specialties. A second page of the form can allow providers put in their locations, and check the types of specialties each location is. The second form can have an address field, along with specialty radio buttons, and the ability to check more than one button. When an address is input, a user clicks “submit” causing the site to check the authenticity of the location and the correctness of the address. If it is good, it is added to the cart, and the option of adding another location is presented to the provider, or a second option is presented to simply continue and check out. Providers can be charged for each location. If a provider has five locations, they can be charged 5-times the fee for the specialty they are listed under. At this point, credit card or other payment information can be provided, and authorization can be given for monthly charges to occur.

This monthly charge may be required to maintain the provider's position on the map. The web site can be set up to automatically charge through a merchant account the monthly fees for each customer. This can be done beginning the day they initiate service for the forthcoming month, and the same day each month. The provider can be given an option to cancel instantly, if desired. There can be a no-penalty cancellation; the account simply can be turned off, and the person instantly removed from the database. If a credit card is declined, a 15-day grace period can be allowed during which time the Provider can remain on the system. However, an email notification can be sent out promptly after the card is declined, and/or every two days afterwards, telling the provider to logon on to their account and update their credit card information. A list is preferably also generated and automatically emailed to an administrative email address that lists all customers that have not updated their credit card info in 10 days so that an employee can make a personal call to the provider to remind them to update it. Of course, many alternative price structures are well known, and may be used in some embodiments.

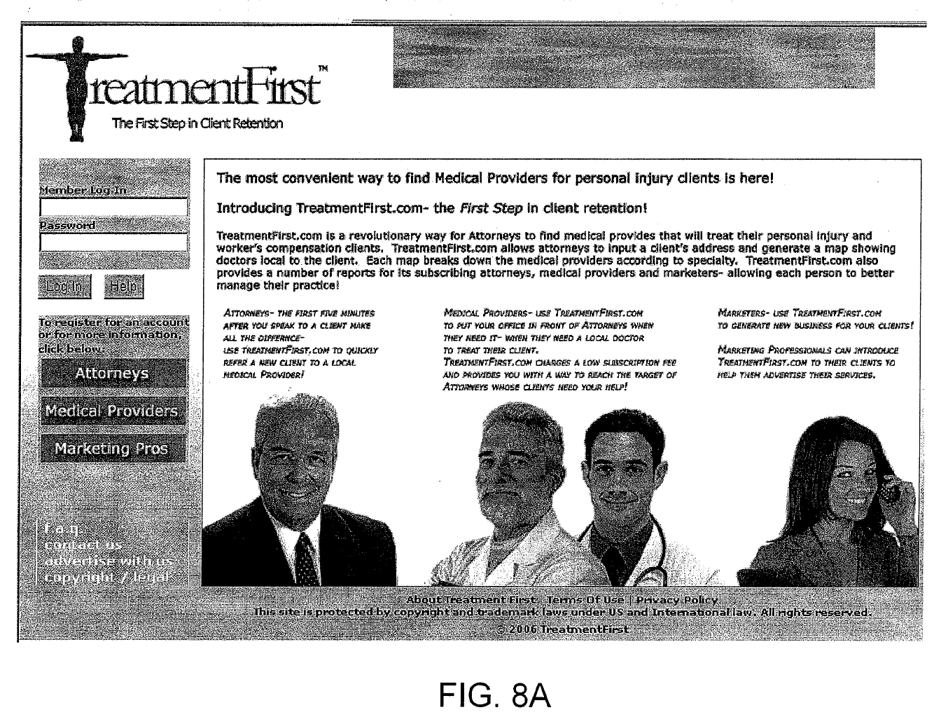

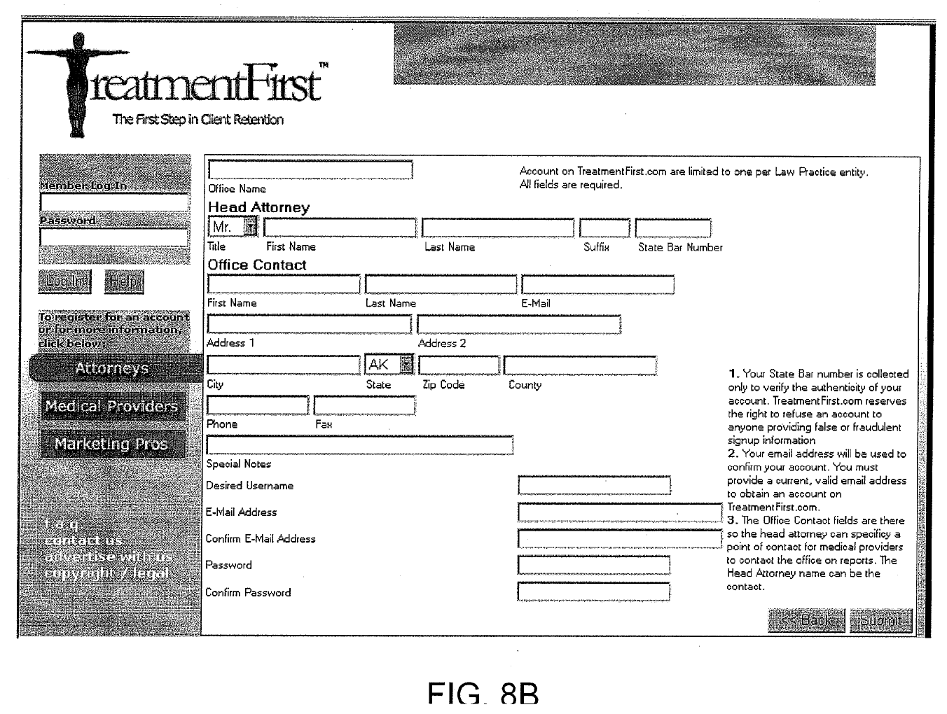

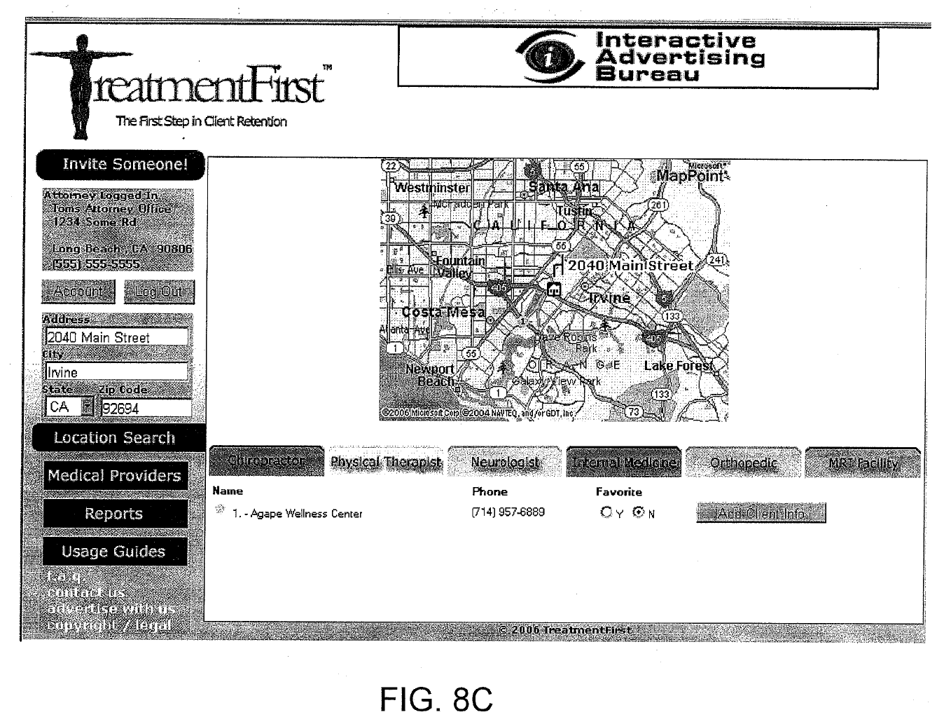

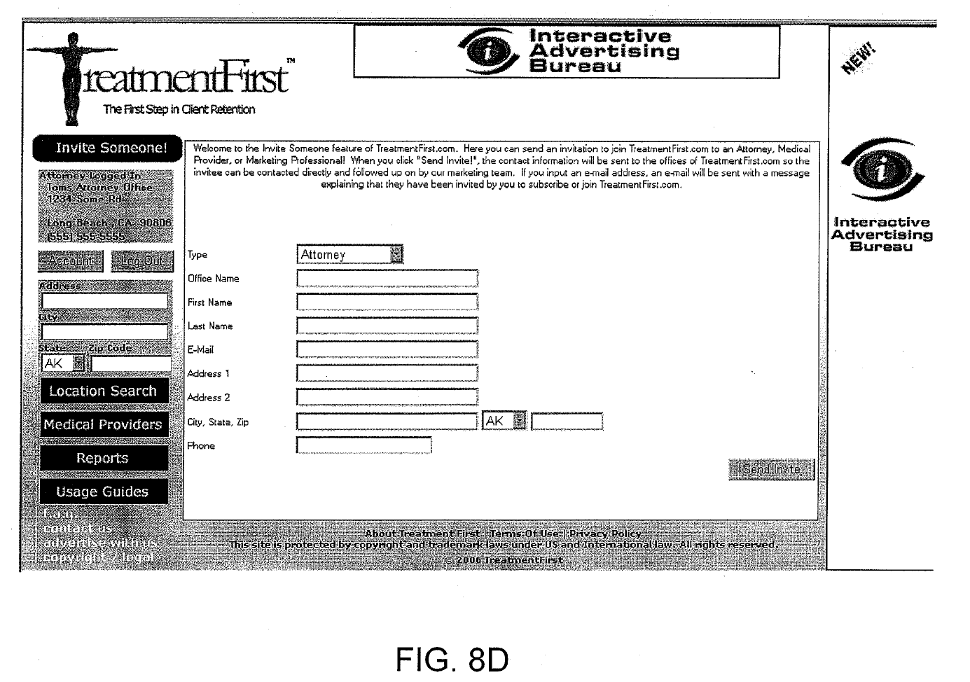

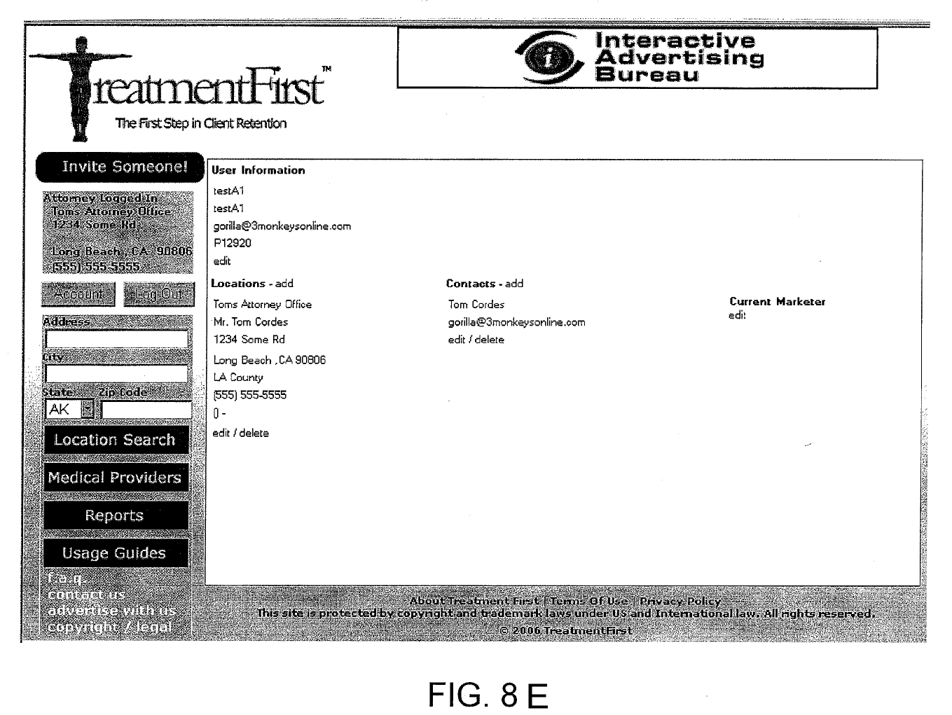

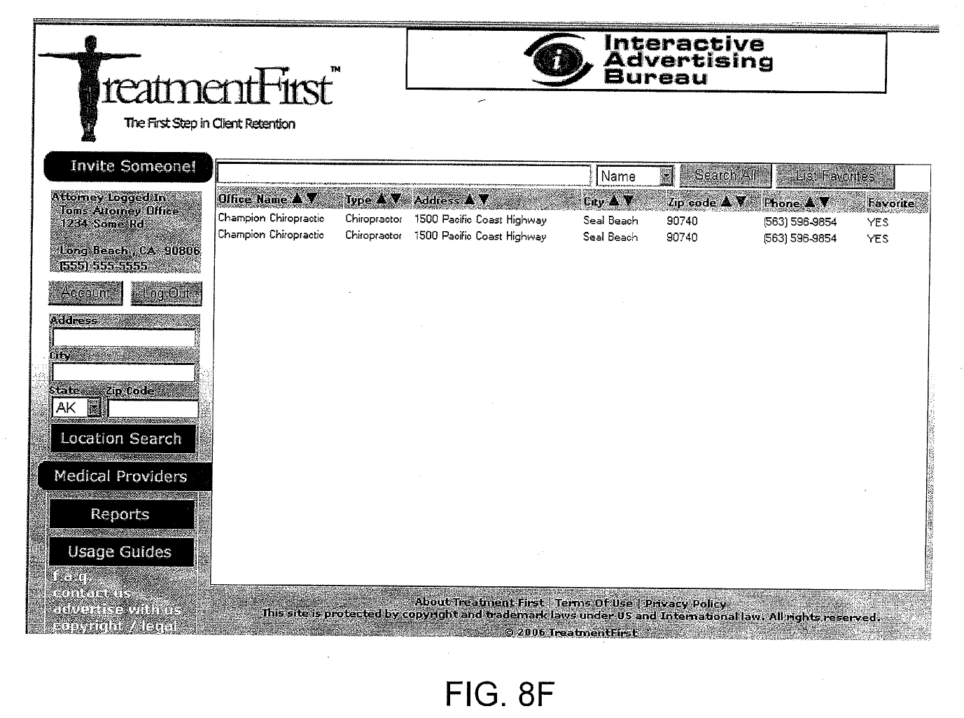

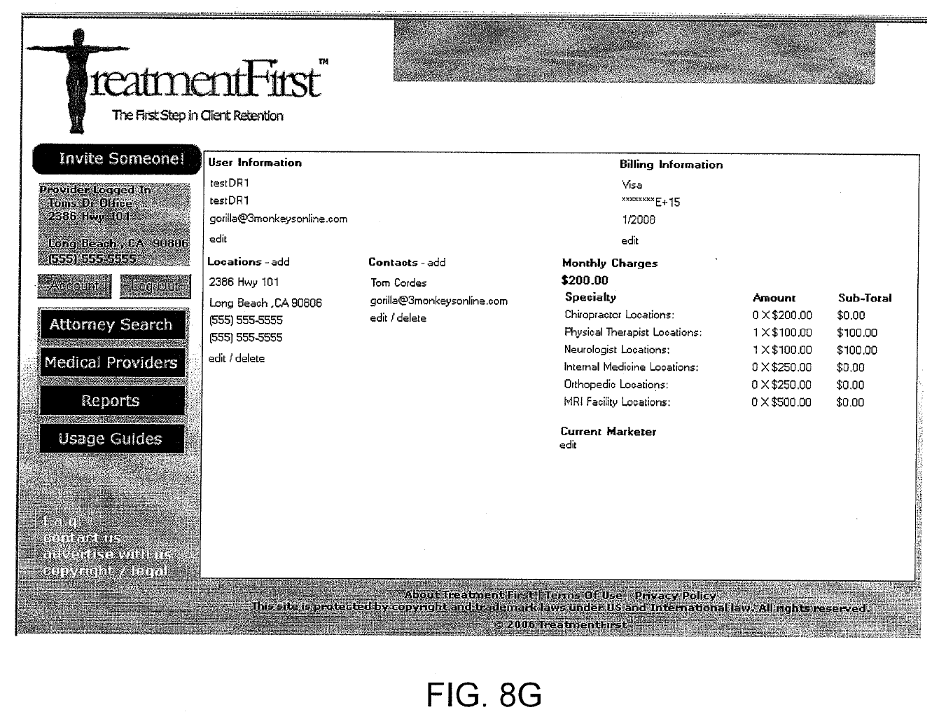

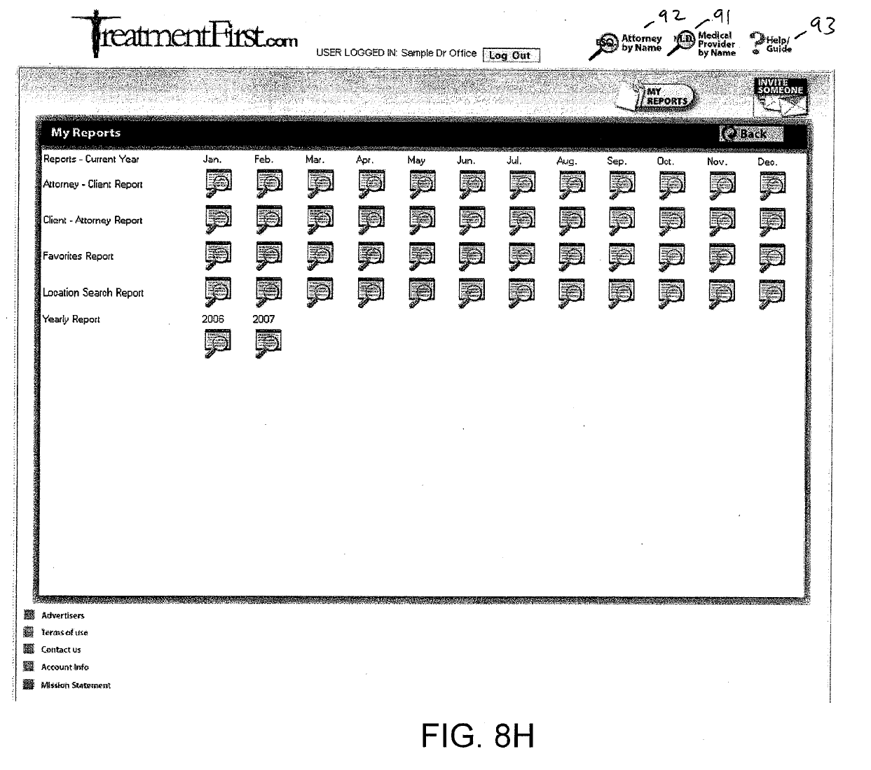

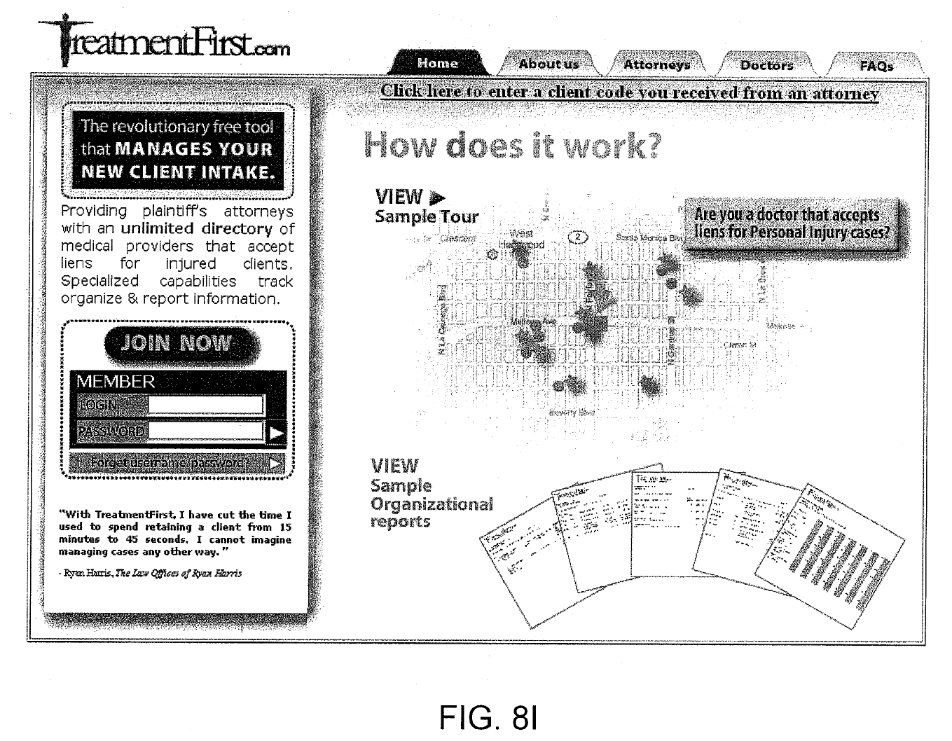

According to some embodiments, attorney users may access the website without payment. In some embodiments, attorneys must register with the site in order to sign up for an account. Requiring an account sign-up may assist in providing and storing account specific features such as ‘favorite’ lists. The registration process may also be used to obtain useful information by requiring the attorney to complete a form page (See FIG. 8B). The following is a nonexclusive list of information that can be advantageously collected when an attorney signs up for a new account: Office Name, Lead Attorney Name, Lead Attorney Bar Number, Office Address, Office Phone Number, Office Contact Person, Office email address, Login name, Login password, etc. In some embodiments, part or all of the information collected in this way may be used to verify the identity of the user. For example, the attorney bar number may be compared with an online database.

In some embodiments, other user types may have accounts. For example, marketing professionals may be able to create accounts. In some embodiments, marketing professional accounts allow access to data associated with attorney or medical provider accounts that are tagged as doing business with the marketing professional. In some embodiments, client accounts are allowed. Client accounts may have access to many of the search features available to attorney or medical provider accounts. In some embodiments, client accounts are not allowed to perform certain functions, such as marking favorites or reporting usage data in order to generate reports.

Website Overview

The system (e.g., website) can be advantageously used to efficiently run an attorney's personal injury or applicant practice by quickly locating desired medical providers. In the past, some attorneys may have attempted to achieve efficiency at the cost of making mistakes that may have driven the attorney's clients away. Fumbling for a medical provider in an area where the user has no knowledge of available medical providers can be a recipe for disaster. Clients often complain about being referred to a medical provider that is not familiar with the attorney that is representing them. This can destroy client confidence and cause them to seek out new representation. But sometimes an attorney does not have the time to play constant catch-up with medical providers or to look for new providers in areas unfamiliar to the user.

The systems described herein (which can for example be embodied, at least in part, by a website such as “TreatmentFirst.com”) can allow the Attorney to delegate the responsibility of setting clients up with medical providers to an employee in the user's firm—while at the same time maintaining the “quality control” that is essential to a well-run practice. The mapping system can display all medical providers that work on a lien within a 15 minute drive-time zone, for example. But “favorites” that the user has marked in the user's account show up on the map as star icons as opposed to regular circles. In addition to the immediate visual cue that the star icon gives, “favorite” medical providers “jump” to the top of the descending list below the map generated after a client location search. This gives the Attorney's employees an easy way to identify those providers to which the Attorney desires to refer clients.

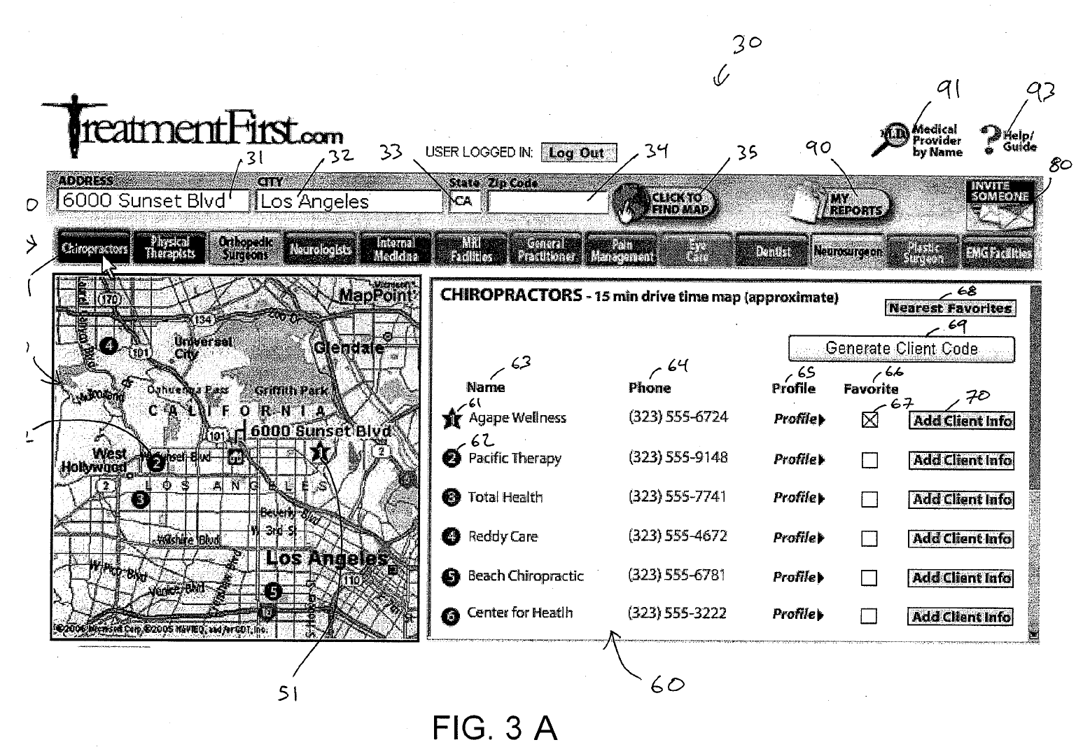

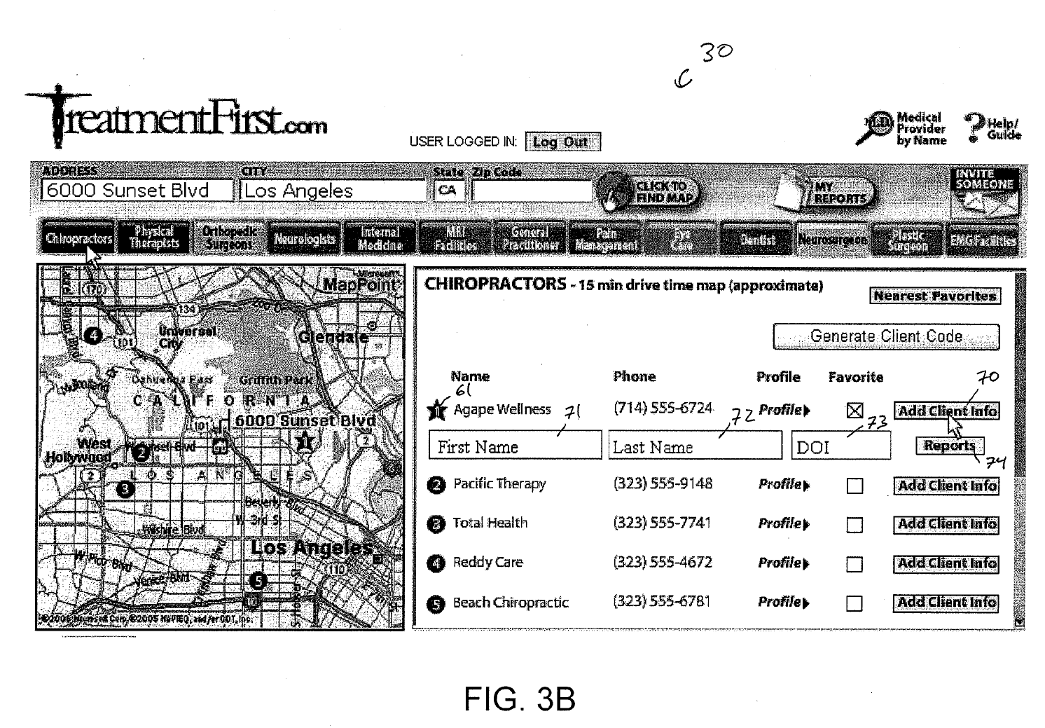

FIG. 3A is an example graphical interface showing a website 30 according to one embodiment of this system. Website 30 includes address entry boxes 31, 32, 33, and 34 corresponding to a street address, city, state, and zip code, respectively. In a preferred embodiment, an attorney, employee, or other user that is logged in to the website 30 enters as much of a client address as is known into these entry boxes 31-34. The attorney may then select the ‘Click to Find Map’ button 35 to generate a map 50 centered on the client address.

Various mapping functions can be incorporated into the system. In some embodiments, there are various mapping options. For example, MapPoint web service is available from Microsoft, and MapQuest is available from MapQuest.com. In some embodiments, MapQuest's first-level API, “Site Advantage,” can be used. Alternatively, MapQuest's second-level service, “Advantage API” and MapQuest's LSSS server can be used. In some embodiments, an API can be selected that has the ability to render according to a drive-time zone; this can be useful for users such as attorneys so that such information can be provided to clients of the user. In some embodiments, the full level 3 API, “Advantage Enterprise,” can be used. Any web-based mapping system can advantageously be used to provide a mapping function. In some embodiments, directions can be provided. In some embodiments, no mapping service is provided.

In some embodiments, the map 50 is rendered to display an area and zoom level corresponding to a height and width of a predetermined number of miles or kilometers. In some embodiments, the size of the geographic area displayed in map 50 is determined according to an approximation of a drive-time zone. In some embodiments, the map size or drive-time zone is determined at least in part based upon a selected specialty. In some embodiments, if a client's location has no providers in a given specialty that are within the map's default rendering distance, then the map can automatically re-render to show the nearest provider. In some embodiments the map 50 is dynamically sized and scaled. In such embodiments the displayed geographical area of the map 50 may be expanded to include the office locations of a predetermined number of providers while providing an appropriate zoom level. In some embodiments, well known electronic map controls are available that allow the user to pan, zoom in, zoom out, or the like.

The website 30 can further include specialty tabs 40. In a preferred embodiment, specialty tabs 40 identify a number of medical specialties associated with medical providers subscribed to the service. For example, FIG. 3A shows the “chiropractors” specialty tab 41 selected. In the embodiment shown, specialty tabs 40 further include tabs corresponding to: physical therapists; orthopedic surgeons; neurologists; internal medicine; MRI facilities; general practitioners; pain management; eye care; dentists; neurosurgeons; plastic surgeons; and EMG facilities. In some embodiments, other specialties are included in the group of specialty tabs 40. In some embodiments, one or more of the specialty tabs 40 shown in FIG. 3A are not included.

When an attorney selects a one of the tabs 40, the map 50 is updated to display the office locations of providers that correspond to the selected tab and that are located near the address provided in entry boxes 31-34. In some embodiments, the Attorney may select a tab to generate a map 50 rather than selecting the ‘Click to Find Map’ button 35. In some embodiments, selecting the ‘Click to Find Map’ button 35 displays providers associated with one of the specialties. The specialty of the providers may be a default specialty determined by the system or selected by the attorney. In some embodiments, the button 35 displays a map 50 with no medical provider locations displayed.

The tabs, when selected, can render the map for their respective specialties. The rendering for each specialty is preferably done in such a way as to conserve map rendering transaction costs. If a default (e.g., most used) specialty is rendered and there are five providers within a five minute drive time in each specialty, it is quite possible that the attorney can just want a provider from the default specialty. If the map does not automatically render the other specialties, mapquest transaction hits can be minimized. Each subscribing provider location can be stored discreetly as a user selects one tab and then another, “tabbing through” various specialties. If a tab that is clicked is clicked a second time, it preferably does not refresh itself by re-rendering the map. The stored map may preferably be reloaded from the web browser cache. In some embodiments, maps can be freshly rendered each time a new address is input in to the system. Logging in and out of the website can clear the cache of maps.

In FIG. 3A, the chiropractors tab 41 has been selected. The map 50 displays five subscribing chiropractor locations including favorite marker 51 (also referred to as an ‘icon’) and marker 52. In a preferred embodiment, these markers or icons are color-coded to match the color of the selected tab. For example, the chiropractors tab 41 may be red, and the markers displayed on map 50 corresponding to chiropractor locations may be red as well. Each of the other tabs 40 and the corresponding markers indicating provider locations may be a different color—green, blue, purple, orange, etc. In some embodiments, markers are not identified by color. For example, a selected tab 40 may be highlighted to identify the specialty of providers displayed on the map 50.

In a preferred embodiment, markers are displayed on the map only for those providers corresponding to the selected specialty. In some embodiments, multiple specialties may be displayed. For example, selecting the button 35 may generate the map 50, which can be centered on the provided address. Selecting the button 35 can also display the nearest providers, regardless of their specialties. In some embodiments, controls may be provided so that the attorney may select multiple specialties to display in any combination.

Website 40 further comprises a list 60 of providers. The list 60 can display Providers in descending order away from the client's location according to their proximity to the original address as input by the attorney. In a preferred embodiment, the list 60 displays content associated with each Provider, including: a provider name list heading 63; a provider phone number list heading 64; a profile heading 65 (underneath which can be found buttons that, when selected, can expand a view of more detailed provider information); a favorite list heading 66, underneath which can be located boxes 67 that can be selected to indicate favorites; a “nearest favorites” button 68, which can allow generation of a list of favorites within a certain radius (as measured by distance or drive time, for example) of the input address; a “generate client code” button; and an “add client info” button 70 that allows the entry of information useful in generating reports. In some embodiments, other information or controls associated with each provider are available in the list 60. For example, information can be listed (e.g., in an additional column that is not illustrated) showing the distance from the address to that particular provider. Thus, a map need not be provided, because the distance and/or drive-time information can be provided in numerical format.

In the list 60 shown in FIG. 3A, six providers are shown. The first five providers listed correspond to markers displayed on the map 50. In some embodiments, a maximum number (e.g., five) of provider locations are displayed on the map 50. A limitation like this can allow efficient rendering and avoid additional map rendering costs, for example. In some embodiments without such a limitation, any provider location located within the geographic region encompassed by map 50 may be displayed on map 50.

The markers (e.g., the favorite marker 61 and the marker 62) corresponding to the listed providers each include a number identifying the provider. For the first five listed providers, this number corresponds to a number shown on the markers displayed on map 50. For example, the star-shaped favorite marker 61 in list 60 corresponds to the star-shaped favorite marker 51 in map 50, and each is labeled ‘1’. This association may help an attorney or some other user locate and identify each provider on the map 50.

The standard markers or icons can be colored dots on the map 50 or list 60, and favorites can be designated by a star shaped icon of the same color in order to emphasize medical providers that are favorites. For example, as indicated by the ‘x’ in favorite selection box 67 for the first provider, Agape Wellness, the corresponding marker 61 is a star. The favorite selection box 67 corresponding to Pacific Therapy is not selected, indicating that Pacific Therapy is not a favorite provider for this user, and the corresponding marker 62 is a dot.

Preferably, data indicating which providers have been flagged as favorites is stored for each attorney account. When an attorney is logged in to his or her account, providers previously marked as favorites will automatically be identified on the appropriate maps, and new favorites may be added.

Designating a favorite can be as simple as checking a box next to a name that pops up under a map, or checking a box next to a provider's name that pops up under the “provider search” feature. For example, in FIG. 3A a provider may be designated or deselected as a favorite by toggling the corresponding favorite selection box 67. In a preferred embodiment, designating a “Favorite” is a fully internal and confidential decision by the user. For example, a user may decide that a provider offers the best possible value to the user's clients because of the user's perception of the provider's skill or attributes.

Aside from being identified by a visual cue such as a distinctive star marker, medical providers listed as favorites may advantageously be emphasized in listings of medical providers. For example, list 60 has favorite Agape Wellness located at the top, despite the fact that Pacific Therapy is geographically closer to the client address. Other ways of emphasizing a favorite are also possible, such as using a different font, highlighting with a color, etc.

Referring to FIG. 3A, the functionality of several other buttons will be described according to some embodiments. The website 30 includes a “nearest favorites” button 68, which may be used to generate a map and/or a list of one or more favorite medical providers, and which may exclude non-favorite medical providers. For example, if a search returns a list of many (e.g. a dozen) providers, and none of those listed are favorites, selecting the “nearest favorites” button 68 may allow the user to locate preferred medical providers a greater distance from the provided location. The website 30 further comprises a “generate client code” button 69, which can allow an attorney user to generate a code that is associated with the current map and that the client may provide when using the website 30 remotely. In some embodiments, when a user inputs the code, the associated map used to generate the code and the corresponding listing is provided to the client. A “my reports” button 90 may take a user to a directory of reports generated and presented as described below in some embodiments. In some embodiments, “invite someone” button 80 may present the user with a form for inputting information related to another attorney or medical provider. In some embodiments, completing the form will generate an e-mail or letter to be sent to the invitee. The “medical provider by name” button 91 may load a page having a searchable and sortable listing of all or some of the subscribing medical providers, in some embodiments. With reference to FIG. 8H, the “attorney by name” button 92 may provide similar functionality for searching attorney users registered with the Website 30, in some embodiments. Referring again to FIG. 3A, “Help/Guide” button 93 may load a webpage containing system, technical, and other helpful information, in some embodiments. In some embodiments, such a webpage also contains contact information and/or a means for contacting a website administrator, such as a text box for entering a message.

The website 30 further includes “add client info” buttons 70 in the provider list 60. In the embodiment shown, a button 70 is associated with each provider in list 60. In a preferred embodiment, the buttons 70 allow an attorney to enter and submit information relating to a client referral that may be used to assist in generating a report. For example, an attorney utilizing the website 30 may decide to refer his or her client to Agape Wellness. If the attorney wishes to record this referral so that it may be used to generate reports and otherwise monitor the patient within the system, he or she may select the appropriate button 70. In one embodiment shown in FIG. 3B, selecting the “add client info” button 68 associated with Agape Wellness causes additional text entry boxes 71, 72, and 73 to be displayed, along with “reports” button 74.

Text entry boxes 71, 72, and 73 may allow the attorney to enter the client's first name, last name, and date of injury, respectively. In some embodiments, other information may be provided. Selecting the “reports” button 74 can store the information entered into text boxes 71, 72, and 73. In some embodiments, selecting the “reports” button 74 causes other data associated with the referral to be automatically obtained and stored. For example, the time of the referral may automatically be stored.

Data Collection

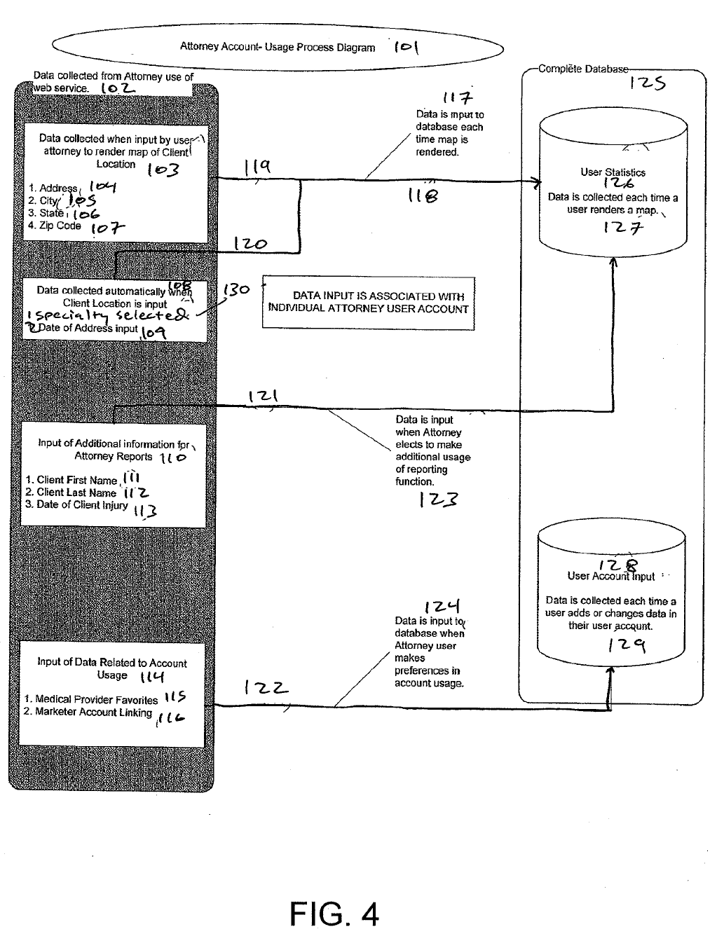

FIG. 4 illustrates one example of a system for data collection and organization. In particular, this diagram illustrates one embodiment of the data collection process 101 for a database of that can provide some or all of the functions described herein. For example, the functions shown in FIG. 4 can be accomplished by an online service. The systems described herein can, through the natural intuitive use by subscribing users, collect various statistics that can be used to provide marketing data for each of the user types shown in FIGS. 1 and/or 2, for example.

At 102, data is collected from an attorney user of the web service. Through the intuitive use of the web service for its intended purpose, the web service collects statistical and specific user input data.

At 103, data can be input by an attorney, employee, or other user. That data can be stored in a database, as indicated. For example, the data can be stored when a map is rendered of the client location corresponding to that data. In some embodiments, some or all of the data used to render a map centered in a specific location is collected by the web service. At 104, street address data may be collected by the web service and stored as a discrete value. At 105, city data may be collected by the web service and stored as a discrete value. At 106, state data may be collected by the web service and stored as a discrete value. At 107, zip code data may be collected by the web service and stored as a discrete value. In some embodiments, other data is input by the user and collected by the system.

At 108, data that is not directly entered into data fields by a user (and/or data not directly associated with the rendering of a map) can also be stored. For example, if the user searches for a particular type of medical specialty, the medical specialty type can be stored and associated with the other data from that location search. Various settings present when the user searches for a location can be stored. At 109, a date of address input is collected by the system. The date of address input may include a date or timestamp that is collected when a map is generated. At 130, data identifying the specialty tab(s) associated with the generated map may be collected by the system.

At 119, data is collected and transmitted as a collection of related values input by the user. In some embodiments, each piece of data input by the attorney user is linked as a transaction when it is entered in to the database as a group. At 120, data collected without input by user, such as date and time information, medical provider specialty, etc. may be attached to the data collected to render the individual map. At 118, collected data is preferably transmitted to a database and stored when map rendering is initiated. Preferably, the collection, transmission, and storage of data is automatic; each time a map is rendered it is collected and stored in the database. In some embodiments, predetermined rules determine whether data associated with a rendered map is collected and stored in a database. In some embodiments, a user or administrator determines when data is collected and stored, for example, by selecting a ‘store data’ button. In some embodiments, all data collected from the initiation of map rendering is collected and stored when the map is actually rendered.

At 110, data is collected as additional information is input by an attorney. As described above, users may have the option of inputting additional values to make the reporting system more useful to them. For example, data can be input relating to case type (e.g., workers compensation, etc.). Moreover, data can be input relating to whether or not a particular client has retained the user and/or provider. In some embodiments, inputting this data is completely optional for the users. At 111, a client first name can be collected. The first name of a client could be used as a convenient identifier of the client in the reports generated. At 112, an attorney user can input a client's last name and that data may be collected. The last name of a client could be used as a convenient identifier of the client in the reports generated. At 113, a date of significance input by an attorney in to the reporting system may be collected. For example, an attorney may input the date the client suffered his or her injury. In some embodiments, additional or different information may be provided by the attorney and collected at 113, such as a description of the client injury, or the like. At 121, the additional information can be input into a database and stored. As shown at 123, this can occur when an attorney elects to make additional usage of reporting function, for example, by entering text associated with a client referral and selecting a “report” button. In some embodiments, this stored data is linked or associated with the data collected at 103 and 108.

At 114, attorney input data that is not related to the rendering of maps, but instead related to the preferences of an account, may be collected. At 115, data associated with a user designation of certain medical providers as preferred in their account is collected. At 116, the system collects an attorney user's link to a marketing account so that the marketer has access to their usage data. At 124, data is input to a database and stored when an attorney user makes changes to preferences in account usage. In some embodiments, these changes are incorporated into the reporting system as data values linked to their account when the user saves their account preferences. In some embodiments, these changes are incorporated into the reporting system and saved automatically when the changes are made, for example, by selecting a ‘favorites’ toggle button associated with a provider.

At 125, an example of a Complete Database is illustrated. The complete database represents all of the information that is input in to the system and stored, either through the process of rendering the maps, automatically collected when that process is initiated, or input and saved as account preferences.

At 126, an example of the User Statistics portion of the database is illustrated. This portion of the database collects usage statistics and stores them. In some embodiments, data is collected each time a user renders a map. In some embodiments, the collected data can be that data directly related to the process of producing a map for the end user. In some embodiments, entries in this database can be associated with: 1) data stored in the user statistics portion of the database; and/or 2) data related to user accounts stored elsewhere in the complete database 125.

At 128, an example of the User Account Input portion of the database is illustrated. This portion of the database stores the individual account preferences for each user. In some embodiments, data is collected each time a user adds or changes data in their user account. Data that is included in the account preferences can be used in order to increase the usefulness of the reporting functions. In some embodiments, the user account input portion may include other account information. For example, account information obtained when an attorney initially registered with the system may be included. In some embodiments, other portions of the complete database may be utilized. For example, the complete database 25 may include a provider data portion, a marketer portion, and the like.

Reports

The data collected, organized, and disseminated by the systems and methods described herein is preferably organized into user-friendly web interface pages and data “reports.” Reports can be used, for example, to help an attorney user manage the user's practice more efficiently. In some embodiments, each report is generated from data associated with the user or the user's employee's use of the website and the searches that are preformed. In some embodiments, the reports can be available to the user for download at the end of the month, and the user's account stores the monthly reports for three months in case the user desires to go back and check the user's history. In some embodiments, reports may be stored for some other period of time or indefinitely. In some embodiments, year summary reports are generated based on activity for the current calendar year. In some embodiments, reports are available to users in a format that is not easily modified, for example, in PDF file format. In some embodiments, reports are formatted and provided to users as spreadsheets that may be searched and sorted by a user. Advantageously, each report can require that the user input the client name to report on certain figures. Examples of reports that can be used, and their descriptions, are provided below. Of course, a skilled artisan will recognize that many other reports may be generated using data obtained from the system, including types of data that are not explicitly stated herein.

Reports for Attorneys

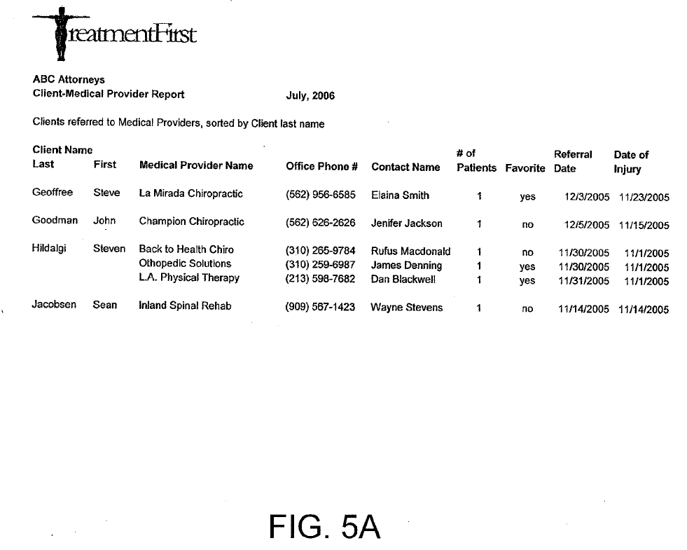

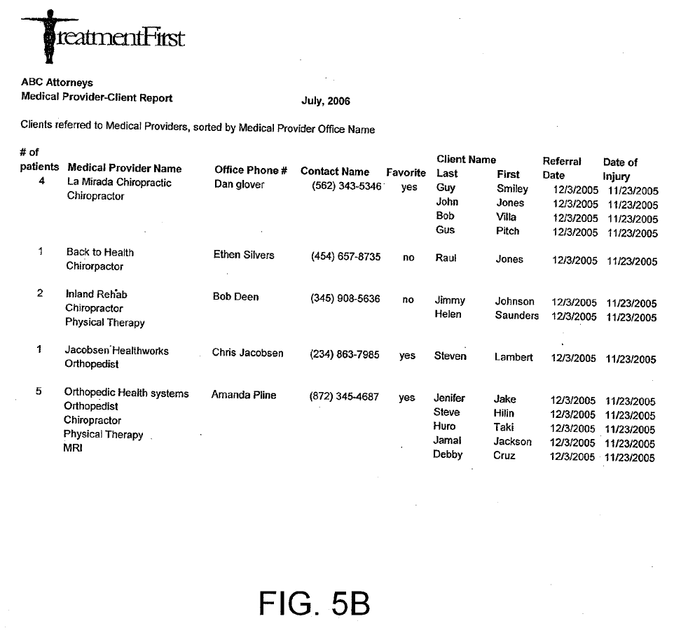

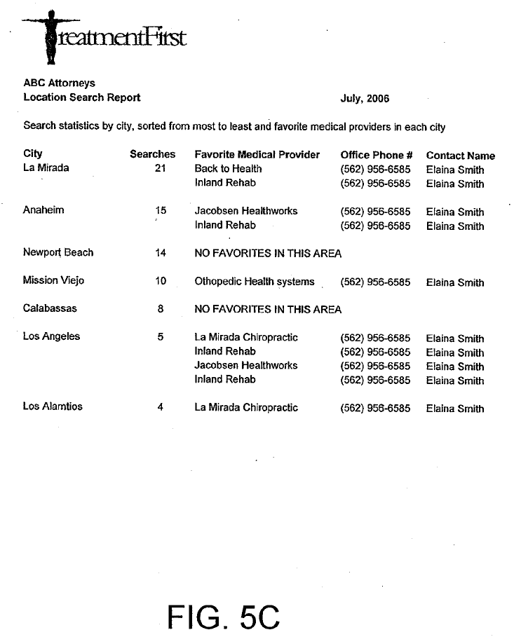

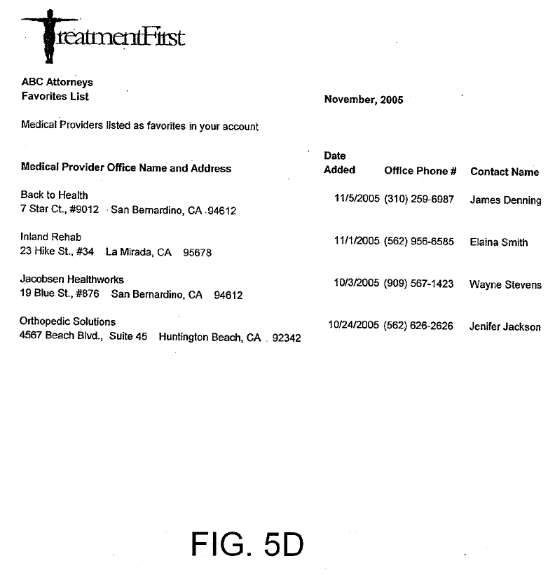

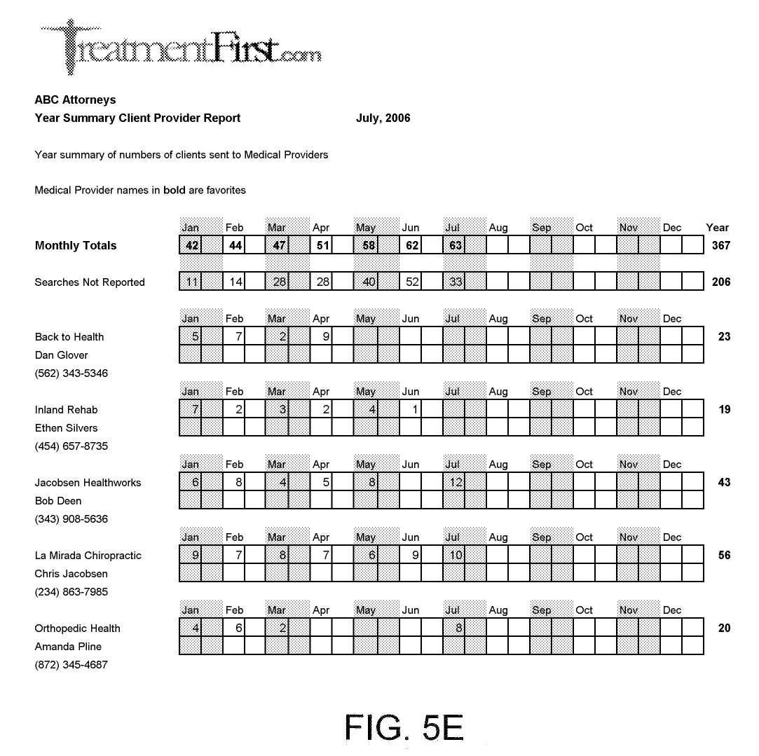

Client Referral Reports (FIGS. 5A and 5B). These reports can be generated to show all the clients that were referred out to medical providers by each individual attorney. The reports can contain information that identifies the clients referred that is taken from the database. The following reports are two example descriptions of how these reports could be generated.

Client-Provider Report (FIG. 5A). The report can sort, in alphabetical order of last name, the information above by client name. In some embodiments, all client names that are duplicates can be listed together, so if the same client is referred to different specialties, they can be grouped together.

Provider-Client Report (FIG. 5B). The report can list the same information above, but according to what provider the client was referred to. There can be a summary number before each provider name totaling the number of referrals.

Location Search Report (FIG. 5C). This report can list the number of searches that the attorney performed in the prior month, broken down by city, listing the favorite medical providers in each city. This report is generated automatically based on the user's location search activity. This report can be a useful tool in showing what areas the user's clients are coming from.

Attorney Favorites List (FIG. 5D). This report lists all of the medical providers and their specialties that the Attorney has listed in his or her account.

Year Summary Client-Provider Report (FIG. 5E). This year end summary report is available to the user all year and the numbers simply total as each month passes. This report shows the user, by month, the number of clients referred to each medical provider. The report is sorted in descending alphabetical order by the name of the medical provider. The report also shows the user accruing year end totals, as well as total number of searches for the month and number of searches not input into the reporting system.

Reports for Providers

The medical provider reports may be similar to the attorney reports in that they can grab information from the actions of the attorneys, but they supply information reports to the medical providers who are subscribing to the service and/or using the data system.

Attorney Referral Reports. These reports can allow the provider to see which attorneys are referring clients. The reports can contain information that identifies the clients referred that is taken from the database.

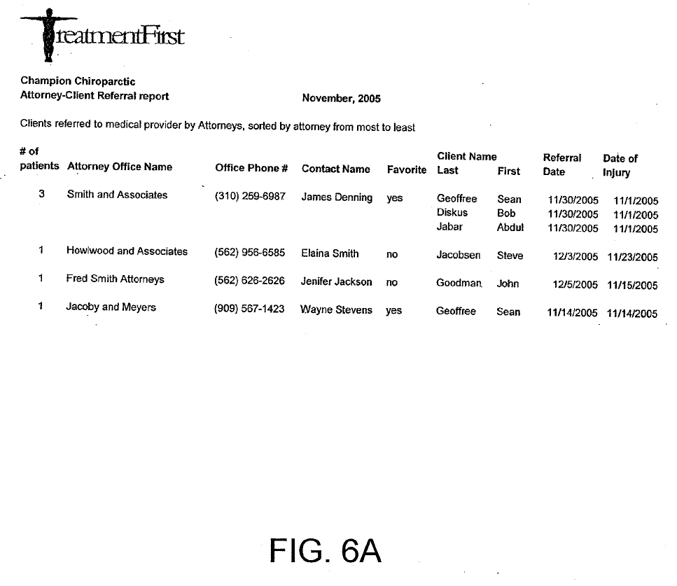

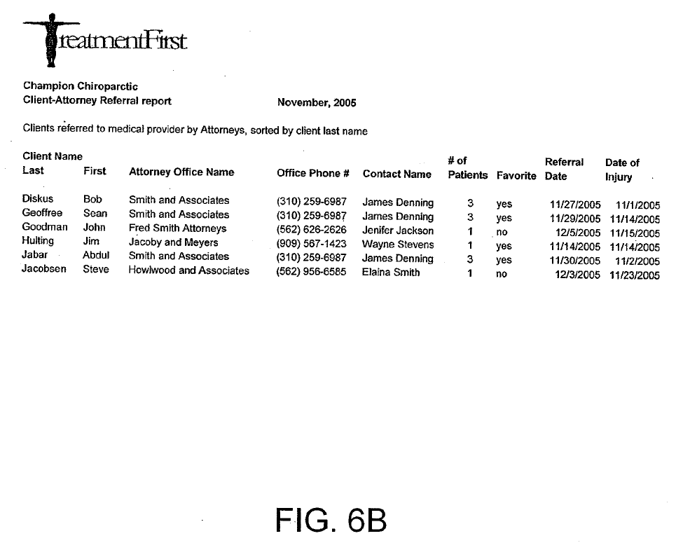

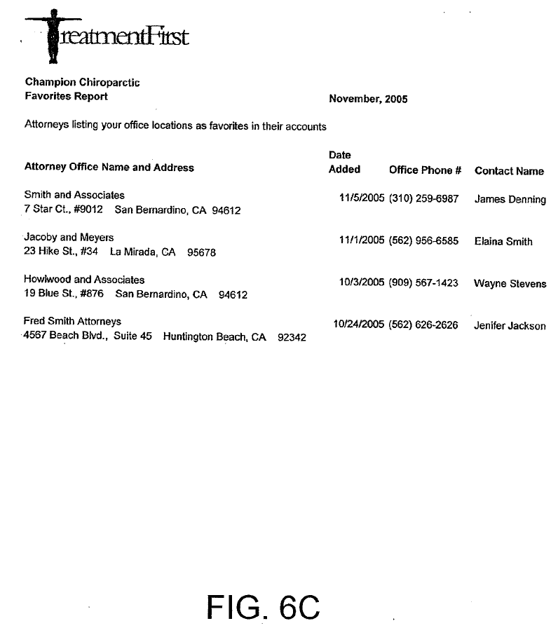

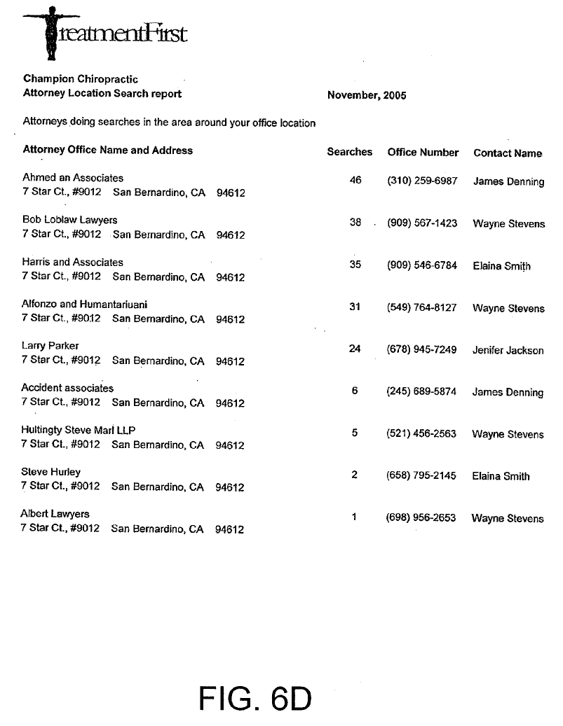

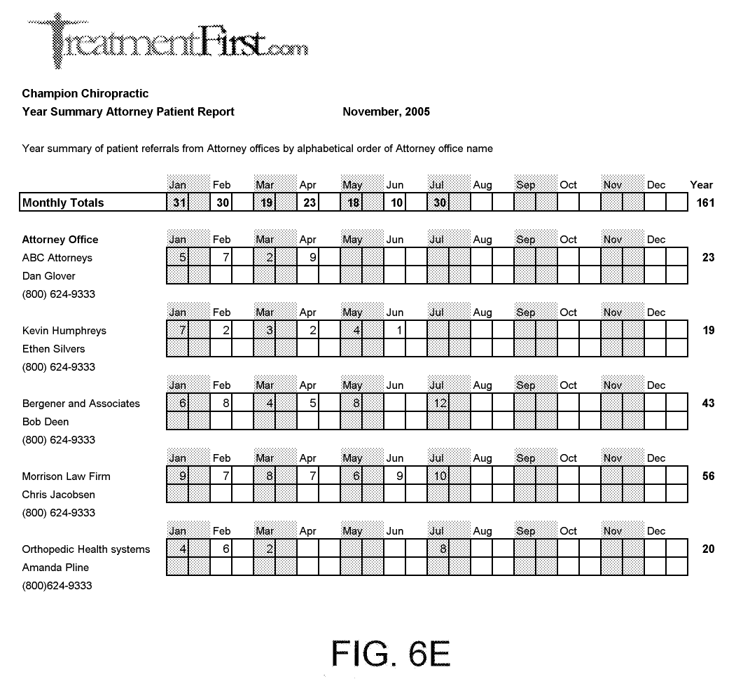

Attorney-Client Referral Report (FIG. 6A). The report can sort, in alphabetical order of last name, the information above by attorney. All attorneys can be listed in descending order by the number of clients they referred to the medical provider. The report can also include the names of the clients referred by the listed attorneys.

Client-Attorney Referral Report (FIG. 6B). This report can provide the same information as the attorney-client report discussed above, but can sort the data according to last name of the client.

Attorney Favorites Report (FIG. 6C). This report lists for the medical provider which attorneys have listed that medical provider as a “favorite” in their attorney accounts.

Attorney Location Search Report (FIG. 6D). This report takes the search data that is input by attorneys and compiles it in to a monthly report for the provider showing which attorneys are doing searches in that provider's area, and how many searches are being done by each attorney. In some embodiments, this report can also contain data relating to which attorneys are designated favorites by the provider that is generating the report.

Year Summary Reports (FIG. 6E). These reports summarize the data collected by the system and/or website that show what medical providers are receiving what clients as referrals.

Client referral reports (not shown). This report can list the number of client address input requests that have been made in to the Provider's city. The report can list, in descending order the attorneys that have made client address search locations, whether or not they have added a provider or used a given provider in their reporting.

Reports for Marketing Professionals

The medical provider and/or attorney may choose to share information with a marketing professional. If one of these users chooses, that user can share the information using the system through a report to a marketing professional who is subscribing to the service.

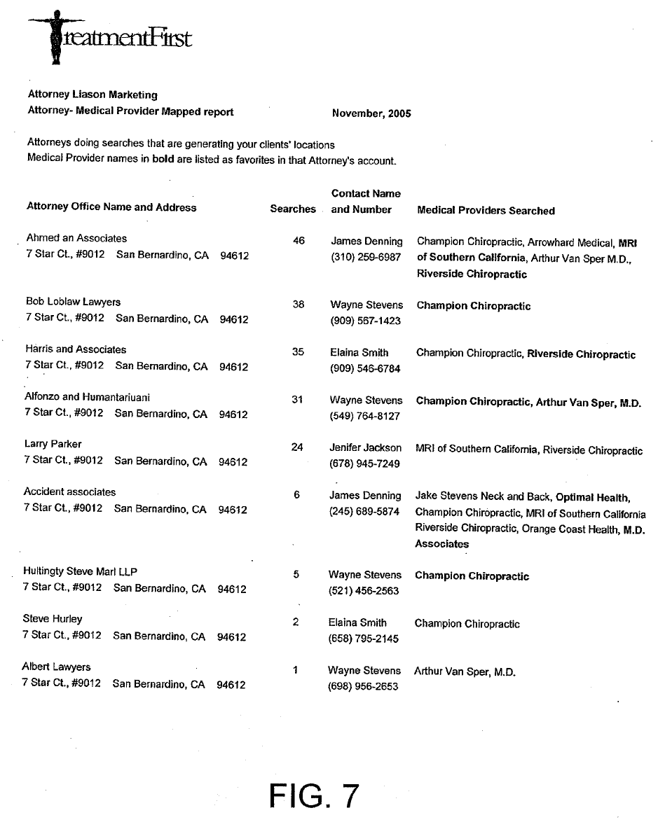

Attorney-Medical Provider Mapped Report (FIG. 7). These reports can allow the marketing professional to see which attorneys are doing searches that are generating the locations of the marketing professional's clients (providers), as well as the other information indicated in FIG. 7.

Other Report Features

In some advantageous embodiments, reports can be automatically generated as monthly reports from a SQL database that gathers all Client address inputs and the attorney accounts that are inputting them, as well as any additional information that the attorney wishes to add by clicking the “add to report” button in the provider list below the map. This database can also contain complete account information from medical and legal providers.

In some embodiments, a feature can be provided for multiple users, including, e.g., all attorneys and medical provider users. The feature can, in some embodiments, be referred to as a “Lien Update Report.” In some advantageous embodiments, this feature is an “active” report between all attorneys and medical providers in which the medical provider can see a listing of information for each client referred that includes the anticipated month of case closure, date of injury, date of referral, and outstanding lien amount. In some embodiments, a Lien Update Report can look like this, for example:

| | | | | | Estimated | Current | |
|---|---|---|---|---|---|---|---|
| Name | | | Date of | Date of | Date of | Billing | Case |
| Last | First | | Injury | Referral | Closure | Amount | Status |
| Barr | Jacob | Bergener and Associates | 06/01/06 | 06/04/06 | June-07 | $120.00 | Open |
| | | (800) 555-1212 | | | | | |

In some embodiments, the Lien Update Report can also provide a column indicating whether or not the case was accepted or rejected.

In some embodiments, the last name, first name, date of injury, and the date of referral, and case status would be input from the reporting system. In some embodiments, the estimated date of closure is editable by the attorneys, the current billing amount is editable by the medical provider, and the case status is a drop-down menu editable by the attorney. In some advantageous embodiments, each cross-report is only be between the attorney and medical provider that has the case, meaning medical providers can see a report that has all the outstanding cases that are with attorneys that have been referred through the system. Similarly, the attorneys can see all of their clients, with the names of the medical provider or providers who have the outstanding lien for the case. Their setup may be the same as above, with the added information of the name of the medical provider. An example is shown here:

| | | | | | Estimated | Current | |
|---|---|---|---|---|---|---|---|
| Name | | | Date of | Date of | Date of | Billing | Case |
| Last | First | | Injury | Referral | Closure | Amount | Status |
| Barr | Jacob | Johnson Orthopedics | 06/01/06 | 06/04/06 | June-07 | $120.00 | Open |
| | | (800) 555-1212 | | | | | |

In some embodiments, this report is “semi-interactive,” meaning each party can update certain aspects of the information on it, keeping the report simpler than some real-time database systems. In some embodiments, the report “automatically” updates when a user clicks on the report. In some embodiments, the features described here use the information input from the reporting system and capturing it, adding it to this cross-reporting system. In some embodiments, the case status column at the end can close out a case when an attorney closes the case and the doctor clicks a button to confirm it.

Administrative Functionality

The website preferably collects data associated with usage and generates reports available to at least an administrator. Data collected may include the number and type of each provider, the number of attorneys, the number of client referrals made, the specialties providers are listed under, fees generated and collected, and the like. All user logons are preferably editable. Full access to the site's data and configuration is preferably available to the administrator. In some embodiments, administrative reports are provided in spreadsheet format so that the data can be sorted and extracted for various purposes.

Other Features

Additional features may be incorporated into some embodiments. For example, the system may automatically generate and send e-mail notification to selected users in response to certain actions. In some embodiments, when an attorney enters client data representing a referral, an e-mail notification is automatically sent to the corresponding medical provider. In some embodiments, a medical provider can indicate the stage of treatment for a patient or enter the charges accrued or due up to that point. An e-mail notification may be sent to the attorney with this information. In some embodiments, when a client e-mail address is provided, an e-mail with information related to a referred medical provider is automatically generated and sent to the client when his or her attorney makes a referral.

In some embodiments, medical provider accounts have similar functionality to that of the attorney accounts. That is, medical providers may be allowed to search for attorneys located near a client, select favorite attorneys, and enter information related to a referral.

In some embodiments, a client may be provided with a client code from an attorney in order to access the system, for example, from home. A client code may be associated with a specific session initiated by the attorney at an earlier time. For example, the attorney may have executed a search during a client meeting, and the results of that search may be available to the client using the code provided. In some embodiments, a client may be given a code that allows for access to the service for a predetermined amount of time, such as one week.

In some embodiments, attorneys can pay for an upgraded service configured to automatically send letters on behalf of the attorney. The service can automatically generate a letter (e.g., on the attorney's letterhead) and send that letter to medical providers to whom that attorney has referred cases. The letter can lists the cases and/or clients that have been referred to the medical provider receiving the letter. In some embodiments, medical providers a similar service can be provided to medical providers. Thus, letters can be automatically sent to legal service providers to whom the medical provider has referred cases, and the letters can be sent on behalf of the medical provider. The data collected and/or stored by the system described herein can be used to create the automatic letters. The automatic letter service can be accessed, in some embodiments, by clicking a button that may be present on a graphic interface such as those depicted in FIGS. 3A and 3B, for example.

In some embodiments, the described systems can be integrated with case management software or other forms of software. For example, a hyperlink can be selected that can take a user from the described system to another system, and the data collected in one system can be input into another system or software.

FIGS. 8A-8G are example graphical interfaces demonstrating some other features of a website according to some embodiments. FIG. 8A shows a homepage including fields for a member log in and password. The page also includes links for help in using the website, and links to allow different types of members to register. FIG. 8B shows a sample attorney registration form. FIG. 8C is another embodiment of a search page showing a client address and nearby medical providers. FIG. 8D is a form allowing a user to invite another user to register with the system. FIG. 8E shows one embodiment of an attorney user information page including the user office locations, contacts, and selected marketing professionals along with controls to edit the information. FIG. 8F shows a searchable listing of medical providers according to one embodiment. FIG. 8G is one embodiment of a medical provider user information page including user office locations, contacts, marketing information, and billing information. In some embodiments, billing information includes a listing of monthly charges organized by specialty listings or office listings. FIG. 8H is one embodiment of a medical provider reports directory. In some embodiments, the reports are organized by type as well as month or year. In some embodiments, selecting the icon corresponding to a report type and time period will display or begin downloading that report. FIG. 8I shows another configuration of a homepage including fields for a member log in and password.

Methods and processes described above may be embodied in, and fully automated via, software code modules executed by one or more general purpose computers. The code modules may be stored in any type of computer-readable medium or other computer storage device. Some or all of the methods may alternatively be embodied in specialized computer hardware. The collected user feedback data (e.g., accept/rejection actions and associated metadata) can be stored in any type of computer data repository, such as relational databases and/or flat files systems.

Reference throughout this specification to “some embodiments” or “an embodiment” means that a particular feature, structure or characteristic described in connection with the embodiment is included in at least some embodiments. Thus, appearances of the phrases “in some embodiments” or “in an embodiment” in various places throughout this specification are not necessarily all referring to the same embodiment. Furthermore, the particular features, structures or characteristics may be combined in any suitable manner, as would be apparent to one of ordinary skill in the art from this disclosure, in one or more embodiments.

Similarly, it should be appreciated that in the above description of embodiments, various features are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that any claim require more features than are expressly recited in that claim. Rather, inventive aspects lie in a combination of fewer than all features of any single foregoing disclosed embodiment.

The foregoing description sets forth various preferred embodiments and other exemplary but non-limiting embodiments of the inventions disclosed herein. The description gives some details regarding combinations and modes of the disclosed inventions. While the system has been described as connecting attorneys and medical providers, it will be understood that some of the concepts described herein may be applied to other user types as well as other systems. For example, the system may be a software application linking suppliers and distributors in certain markets.

Although the invention(s) presented herein have been disclosed in the context of certain preferred embodiments and examples, it will be understood by those skilled in the art that the invention(s) extend beyond the specifically disclosed embodiments to other alternative embodiments and/or uses of the invention(s) and obvious modifications and equivalents thereof Thus, it is intended that the scope of the invention(s) herein disclosed should not be limited by the particular embodiments described above. Other variations, combinations, modifications, modes, and/or applications of the disclosed features and aspects of the embodiments are also within the scope of this disclosure, including those that become apparent to those of skill in the art upon reading this specification. Thus, the scope of the inventions claimed herein should be determined only by a fair reading of the claims.

What is claimed is:

1. A system for communicating a provider list to a user comprising:
a database of providers;
a list of providers geographically selected from the database;
a group of chosen providers;
a display showing the list of providers geographically selected from the database and emphasizing providers that are in the list and in the group of chosen providers.

2. The system of claim 1, further comprising a display showing a map of the area corresponding to the list of providers geographically selected from the database.

3. The system of claim 1, wherein the database of providers comprises a database of medical service providers that accept liens.

4. The system of claim 1, wherein the database of providers comprises a database of legal service providers for personal injury cases.

5. The system of claim 1, wherein the list of providers geographically selected from the database comprises providers within a radius of geographic distance from a user-selectable location.

6. The system of claim 1, wherein the list of providers geographically selected from the database comprises providers within a drive-time radius of a user-selectable location.

7. The system of claim 1, wherein the group of chosen providers is selectable by a user.

8. The system of claim 1, wherein the display showing the list of providers geographically selected from the database and emphasizing providers that are in the list and in the group of chosen providers comprises a list that positions chosen providers at the top of the list.

9. A computer-implemented method of integrating chosen selections into a geographically-selected list, the method comprising:
providing a database of potential providers;
allowing a user to provide place data;
using a computer and the place data to generate a geographically-selected list from the database of potential providers;
allowing the user to choose selections from the database of potential providers;
calculating which providers from the database are both on the geographically-selected list and the list of chosen selections; and
indicating to a user which providers from the database are both on the geographically-selected list and the list of chosen selections.

10. The method of claim 9, further comprising generating a graphic representation of the geographically-selected list for display to the user.

11. The method of claim 10, wherein generating a graphic representation of the geographically-selected list comprises rendering a map.

12. The method of claim 9, wherein providing a database of potential providers comprises providing a database of potential service providers that accept deferred payment based on the outcome of a legal proceeding.

13. The method of claim 12, wherein providing a database of potential service providers that accept deferred payment based on the outcome of a legal proceeding comprises providing a database of personal injury lawyers.

14. The method of claim 12, wherein providing a database of potential service providers that accept deferred payment based on the outcome of a legal proceeding comprises providing a database of medical professionals that accept liens.

15. The method of claim 9, wherein allowing a user to provide place data comprises allowing a user to enter an address;

16. The method of claim 9, wherein indicating to a user which providers from the database are both on the geographically-selected list and the list of chosen selections comprises displaying a list of providers on a computer screen.

17. The method of claim 9, wherein allowing a user to choose selections from the database of potential providers comprises displaying a list of potential providers to a user over a web interface and accepting input from the user regarding each of the providers separately.

18. The method of claim 9, wherein indicating to a user which providers from the database are both on the geographically-selected list and the list of chosen selections comprises displaying a list of selected providers to a user over a web interface.

19. A system for communicating provider information to a user, the system comprising:
a database of providers;
a geographic search engine configured to accept location data and select close providers from the database of providers;
a web-based interface configured to accept input from the user and display provider information to the user;
a tracking system configured to store information relating to the input from the user; and
a report generator configured to retrieve the information relating to the input from the user and display that information to the user.

20. The system of claim 19, wherein the database of providers comprises information relating to medical providers.

21. The system of claim 19, wherein the database of providers comprises information relating to providers of legal services.

22. The system of claim 19, wherein the database of providers comprises information relating to providers of legal and medical services.

23. The system of claim 19, wherein the database of providers comprises information relating to providers of car repair services.

24. The system of claim 19, wherein the geographic search engine configured to select close providers from the database of providers is further configured to select close providers according to a user-selected parameter.

25. The system of claim 19, wherein the report generator is further configured to retrieve information stored by the tracking system.

26. The system of claim 19, wherein the report generator is further configured to display a report showing what medical providers at least one client was referred to.

27. The system of claim 19, wherein the report generator is further configured to display a report showing what medical providers received a client from the user.

28. The system of claim 19, wherein the report generator is further configured to display a report showing how many times, during a given time period, the geographic search engine accepted location data and selected close providers within a certain geographic area.

29. The system of claim 28, wherein the certain geographic area is a municipality.

30. The system of claim 19, wherein the report generator is further configured to display a report showing the number of clients referred to one or more providers for a given time period.

31. The system of claim 19, wherein the report generator is further configured to display a report showing all the clients that were referred to providers by a user.

32. The system of claim 19, wherein the report generator is further configured to display a report showing the clients referred to each provider for a given time period.

33. The system of claim 19, further comprising a list of user-selected favorites, selected from the database of providers.

34. The system of claim 33, wherein the report generator is further configured to display a report showing the list of user-selected favorites.

35. The system of claim 19, wherein the report generator is further configured to display a report showing all providers that referred clients to a user during a given time period.

36. The system of claim 19, wherein the report generator is further configured to display a report showing which providers are using the system to enter location data into the geographic search to locate other providers within a certain geographic area, the certain geographic area selected by the user.

37. The system of claim 36, wherein the user is one of the other providers.

38. The system of claim 36, wherein the report also indicates to the user how many times the geographic search has been used by at least one of the providers.

39. The system of claim 19, wherein the report generator is further configured to display to a provider a report that was generated by a user, wherein the provider is not the user.

40. The system of claim 19, further comprising a favorites only mode, wherein the web-based interface is configured to display only providers that are also user-identified favorites.

41. The system of claim 19, further comprising a letter generator configured to generate letters addressed to one or more providers from a user.

42. The system of claim 41, wherein the letter generator is configured to send data from the tracking system to a system administrator.

43. A method of generating reports comprising:
providing a database of legal and medical providers;
accepting client location data input by a user;
using a computer to search the database to identify legal or medical providers close to the client location;
storing search and provider information;
automatically generating reports having search or provider information;
providing the reports to a user.
